(19) United States
(12) Patent Application Publication
(10) Pub. No.: US 2026/0092672 A1
(43) Pub. Date: Apr. 2, 2026

(54) Adjustment Unit for an Operator Terminal, Operator Terminal for an Environment Simulation Chamber and Environment Chamber

(71) Applicant: Binder GmbH, Tuttlingen (DE)

(72) Inventors: Ewald STORZ, Rietheim-Weilheim (DE); Ante URTIC, Mönchweiler (DE); Richard LEIDOLT, Singen (DE)

(73) Assignee: Binder GmbH, Tuttlingen (DE)

(21) Appl. No.: 19/347,684

(22) Filed: Oct. 1, 2025

(30) Foreign Application Priority Data
Oct. 2, 2024 (DE) 1020241285753

(51) Int. Cl. F16M 11/18

(52) U.S. Cl. CPC F16M 11/18; F16M 2200/022; F16M 2200/024

(57) ABSTRACT

An adjustment unit for an operator terminal used with environment simulation chambers comprises a first flap element and a second flap element connected by a rotational axis for relative rotation. A latching element disposed on the first flap element includes latching recesses, while a support element on the second flap element engages the latching recesses to secure angular positioning. A slide mechanism that moves along a sliding axis between two positions to selectively block or unblock the latching recesses. In a first position, the slide allows the support element to engage the latching recesses for secure positioning. In a second position, the slide blocks the latching recesses, preventing engagement and allowing free rotation. The slide includes entrainment projections that interact with the support element during rotation to automatically control slide positioning and prevents unintentional displacement while maintaining simple operation for industrial environments requiring frequent terminal adjustment.

### CROSS REFERENCE TO RELATED APPLICATIONS

This application claims priority under 35 U.S.C. § 119(a) to German Patent Application No. 10 2024 128 575.3, filed Oct. 2, 2024, the entire disclosure of which is hereby incorporated by reference.

### FIELD OF DISCLOSURE

The application relates to an adjustment unit for an operator terminal, operator terminal for an environment simulation chamber as well as environment simulation chamber.

### BACKGROUND

Environment simulation chambers are utilized in many fields of natural science and technology in order to simulate specific climatic conditions. Input and/or output for controlling such environment simulation chamber conventionally take place by means of an operator terminal disposed on an outer side of the environment simulation chamber. The operator terminal herein typically comprises a screen and/or control keys for the exchange of data between a user and the environment simulation chamber.

To attain the best feasible operability, prior art disposes the operator terminal at an angle depending on constraints such as placement site of the environment simulation chamber or the physical size of the user. Such disposition is described, for example, in WO 2004 062 157 A2. In order to be able to adapt the display of a device to changing constraints EP 3 935 331 B1, DE 10 2005 063 090 A1 or DE 100 54 912 A1, for example, furthermore disclose developing the display such that it is adjustable. US 2001 0 052 741 A1 moreover shows an installation in which latching positions at several angles of inclination are provided.

The known solutions entail the disadvantage that the displays either cannot be secured in place at all or that by applying pressure onto the display it can be moved out of its latched position. The known solutions are therefore not suitable for industrial employment, in particular for environment simulation chambers in which the operator terminals are subject to frequent use and users occasionally work in protective clothing.

### SUMMARY

The application therefore addresses the problem of making available an apparatus with which an operator terminal can be disposed at an angle on a device such that the disposition can be handled robustly and simply and includes a long operating life. The application further addresses the problem of making available an operator terminal with such an apparatus as well as an environment simulation chamber with a corresponding operator terminal.

According to the disclosure the problems are resolved through an adjustment unit, an operator terminal as well as an environment simulation chamber as described herein.

Advantageous embodiments and further developments are specified in the dependent claims.

An adjustment unit for an operator terminal comprises a first flap element, a second flap element, a rotational axis about which the first flap element and the second flap element can be turned with respect to one another, a latching element disposed on the first flap element and comprising at least one latching recess, and a support element disposed on the second flap element and disposable in one of the at least one latching recesses.

Through the disposition of the support element in the at least one latching recess the support element can be braced in the at least one latching recess. The support element can be disposed on the second flap element such that it is rotatable.

The adjustment unit comprises a slide that is displaceable along a sliding axis wherein the slide is disposable in a first position such that the at least one latching recess is unblocked for the disposition of the support element and wherein the slide is disposable in a second position such that the at least one latching recess is blocked for the disposition of the support element. Through such disposition the at least one latching recess can be defined to be blocked or unblocked for the disposition of the support element. Thereby a robust adjustment unit for an operator terminal can be provided. The slide can be displaceable from the first position into the second position and conversely along the sliding axis. In the first position the slide is preferably disposed such that the support element can be inserted into the at least one latching recess. In the second position the slide is preferably disposed such that the support element is not insertable into the at least one latching recess.

In an embodiment, the slide comprises a first entrainment projection and a second entrainment projection disposed with respect to the sliding axis opposite the first entrainment, wherein on the first entrainment projection is disposable the support element for displacing the slide from the second position into the first position and/or on the second entrainment projection is disposable the support element for displacing the slide from the first position into the second position.

In this manner the slide can be displaceable by means of the support element. In particular, a rotational movement of the two flap elements with respect to one another about the rotational axis can therewith effect the displacement of the slide along the sliding axis.

The slide preferably comprises a base body with a C-shaped slot, wherein the first entrainment projection and the second entrainment projection are each formed by a slot end of the slot. The support element can in this way be moved in the slot from the second entrainment projection to the first entrainment projection.

The slide can comprise at least one slide recess wherein in the first position the at least one latching recess and the at least one slide recess are preferably disposed such that they are in alignment with one another. When viewing the configuration transversely to the sliding axis, the at least one latching recess and the at least one slide recess are in flush alignment with one another. In this way the at least one latching recess can be unblocked for the disposition of the support element in the at least one latching recess. In the first position of the slide the support element can therewith be disposed in the at least one latching recess and simultaneously in the at least one slide recess. The number of the at least one slide recesses preferably corresponds to the number of the at least one latching recesses. It is especially preferred for the latching element to comprise three latching recesses which are disposed successively along the sliding axis and can each comprise the features of the at least one latching recess. The first flap element and the second flap element can thereby be secured in place in three different positions with respect to one another. The latching recesses are preferably developed identically. The slide recesses can also be developed identically.

With respect to the sliding axis the at least one slide recess is preferably disposed between the first entrainment projection and the second entrainment projection. The at least one slide recess can be disposed in particular in the C-form slot.

Each of the at least one latching recesses can comprise a latching recess contour with a first end segment and a second end segment, wherein the first end segment is disposed perpendicularly to the sliding axis and/or the second end segment is disposed obliquely with respect to the sliding axis. With a multiplicity of latching recesses, disposed successively along the sliding axis, the slide can therewith comprise a sawtooth contour disposed along the sliding axis. By disposing the first end segment perpendicularly to the sliding axis, the support element can be braced on the first end segment of the at least one latching recess. By disposing the second end segment obliquely with respect to the sliding axis, the support element can slide out of the at least one latching recess at the second end segment of the at least one latching recess.

The at least one slide recess can comprise a slide recess contour which is at least segmentally developed to be geometrically similar to the latching recess contour. The slide recess contour can herein be developed to be centrally stretched with respect to the latching recess contour such that in the first position of the slide the at least one slide recess is set back with respect to the at least one latching recess contour. A defined bracing of the support element in the latching recess can thereby be attained. Corresponding to the latching recess contour, the slide recess contour can comprise a first end segment that is shorter than the first end segment of the latching recess contour. The support element can thereby be prevented from becoming jammed.

The at least one latching recess is preferably disposed such that the first end segment is oriented toward the first entrainment projection and the second end segment is oriented toward the second entrainment projection. The first end segment of the latching recess contour is therewith disposed closer to the first entrainment projection than is the second end segment of the latching recess contour.

The latching element preferably comprises a first latching element part, a second latching element part and a slide groove, extending along the sliding axis between the first latching element part and the second latching element part, in which the slide is disposed. Each of the at least one latching recesses is preferably disposed in the first latching element part and in the second latching element part such that each of the at least one latching recesses preferably intersects the slide groove.

In a further development, the latching element and/or the slide comprise impedants for increasing the friction between the latching element and the slide. Thereby the displacement of the slide can be avoided in the event the support element is not disposed in the at least one latching recess respectively in the at least one slide recess.

The impedants are preferably developed as impedant projections disposed on the slide and/or on the latching element. The impedants can be disposed in particular on a back side of the slide disposed opposite the slot and/or on a side surface disposed lateral to the slot of the slide. It is likewise conceivable to dispose the impedants in the slide groove.

In an embodiment, the adjustment unit comprises a hold-down clamp, preferably developed as a leaf spring, for guiding the support element. In order to displace the slide, the support element can therewith be retained in the slot. In addition, in the first position the support element can thereby be latched in the at least one latching recess. The hold-down clamp can be developed in the form of a U and/or at least segmentally can be disposed in the slot.

Between the slide and the hold-down clamp an air gap can be disposed. The displacement force required for displacing the slide can thereby be set independently of the latching force which is required for unlatching the support element out of the at least one latching element. The support element is preferably developed as a bracket disposed between the hold-down clamp and the slide.

An operator terminal, in particular for an environment simulation chamber, comprises the above described adjustment unit, wherein the first flap element is developed as an operating part and the second flap element is developed as a base part of the operator terminal.

The operating part preferably comprises an input unit and/or an output unit for the entry and output of data or commands respectively. The base part can be developed, for example, for the disposition of the operator terminal on the environment simulation chamber or as part of the environment simulation chamber. The operator terminal can consequently be disposed at an angle of inclination on an environment simulation chamber.

An environment simulation chamber comprises the above described operator terminal.

### BRIEF DESCRIPTION OF THE DRAWINGS

An embodiment example will be explained in conjunction with the following Figures. Therein depict:

FIG. 1 a perspective view of an embodiment example of an operator terminal with a detail marked A,

FIG. 2 a detail view of the detail marked A in FIG. 1,

FIG. 3 a perspective view of the embodiment example depicted in FIG. 1 with obscured hold-down clamp and detail marked B,

FIG. 4 a detail view of the detail marked B in FIG. 3,

FIG. 5 a sectional view of the embodiment example depicted in FIG. 1 in a first state with detail marked C,

FIG. 6 a detail view of the detail marked C in FIG. 5,

FIG. 7 a sectional view of the embodiment example depicted in FIG. 1 in a second state with detail marked D,

FIG. 8 a detail view of the detail marked D in FIG. 7,

FIG. 9 a sectional view of the embodiment example depicted in FIG. 1 in a third state with detail marked E,

FIG. 10 a detail view of the detail marked E in FIG. 9,

FIG. 11 a perspective view of the slide of the embodiment example depicted in FIG. 1,

FIG. 12 an exploded view of the embodiment example depicted in FIG. 1,

FIG. 13 a perspective view of a first embodiment example of an environment simulation chamber,

FIG. 14 a perspective view of a second embodiment example of an environment simulation chamber.

### DETAILED DESCRIPTION

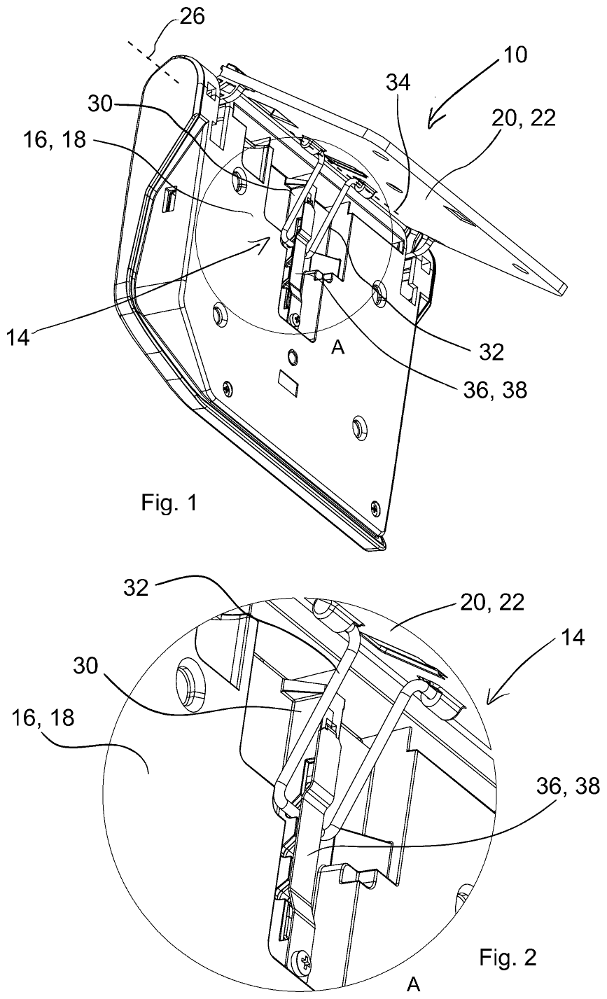

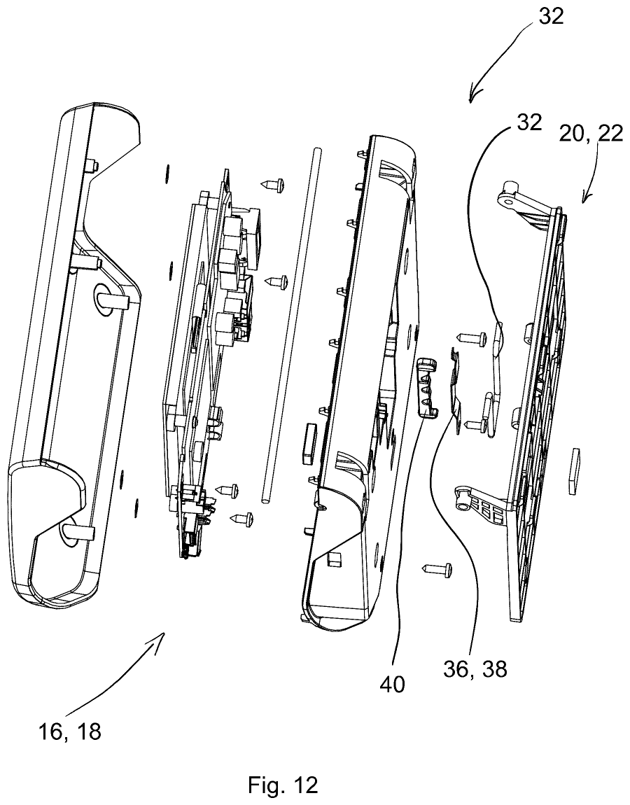

FIGS. 1 to 14 show different embodiment examples. For same and functionally same parts the same reference symbols are used. For better clarity of view not all reference symbols are used in every Figure.

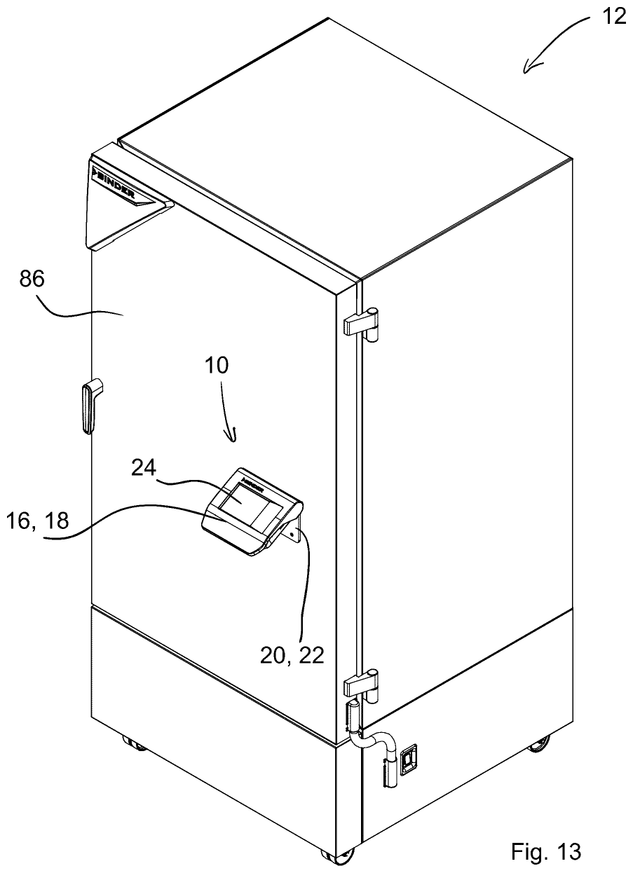

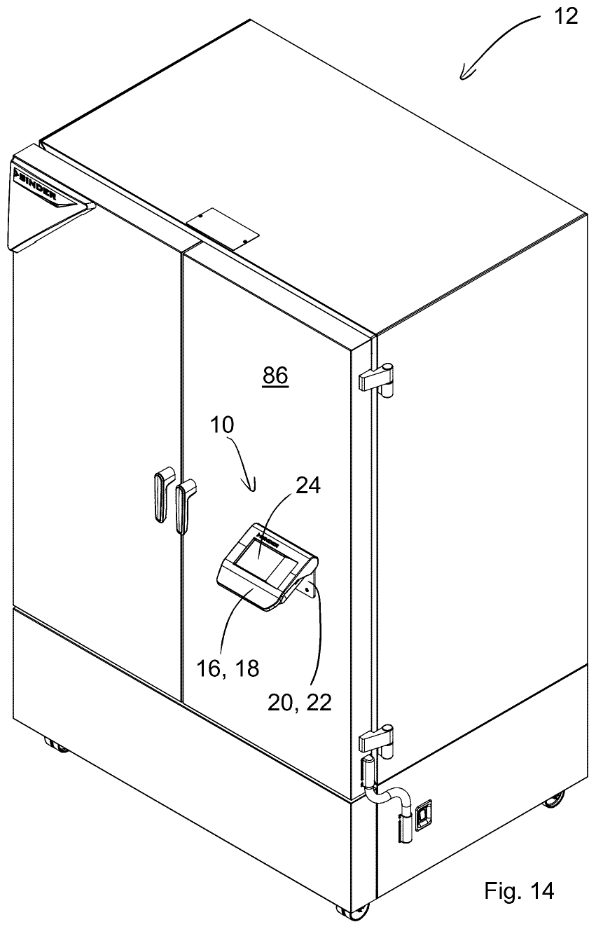

FIG. 1 shows a perspective view of an operator terminal 10 for an environment simulation chamber 12 with an adjustment unit 14. The adjustment unit 14 comprises a first flap element 18 developed as an operating part 16 and a second flap element 22 developed as a base part 20. In FIGS. 13 and 14 the operating part 16 is shown from the front. It can herein be recognized that the operating part 16 can comprise an input unit and/or an output unit 24 for the input and/or output of data or commands, respectively. FIGS. 13 and 14 also show that the base part 20 can be developed for the disposition of the operator terminal 10 on the environment simulation chamber 12. By means of the adjustment unit 14 the operator terminal 10 can be disposed at an inclination on the environment simulation chamber 12.

The representation in FIGS. 1 and 2 shows that the adjustment unit 14 comprises a rotational axis 26 about which the operating part 16 and the base part 20 can be turned relative to one another. The adjustment unit 14 preferably comprises further a latching element 30 disposed on the operating part 16 and comprising several latching recesses 28 as well as a support element disposed on the base part 20 and disposable in each of the latching recesses 28. By disposing the support element 32 in one of the latching recesses 28 the support element 32 can be braced in the particular latching recess 28. The support element 32 can be disposed on the base part 20 such that it is rotatable about a support element axis 34.

As FIGS. 1 and 2 further show the adjustment unit 14 can comprise a hold-down clamp 38 developed as a leaf spring 36. The hold-down clamp 38 can in particular be disposed on the latching element 30.

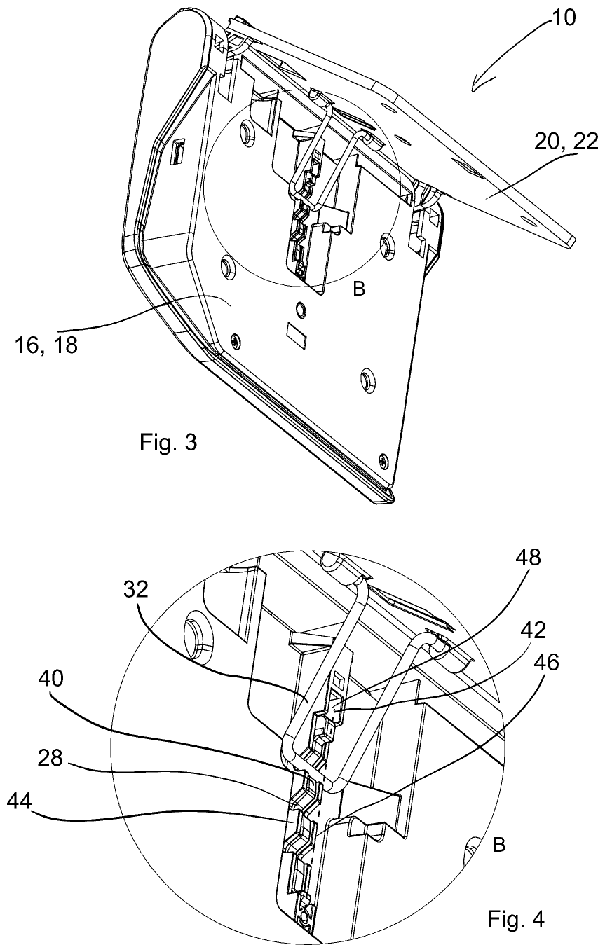

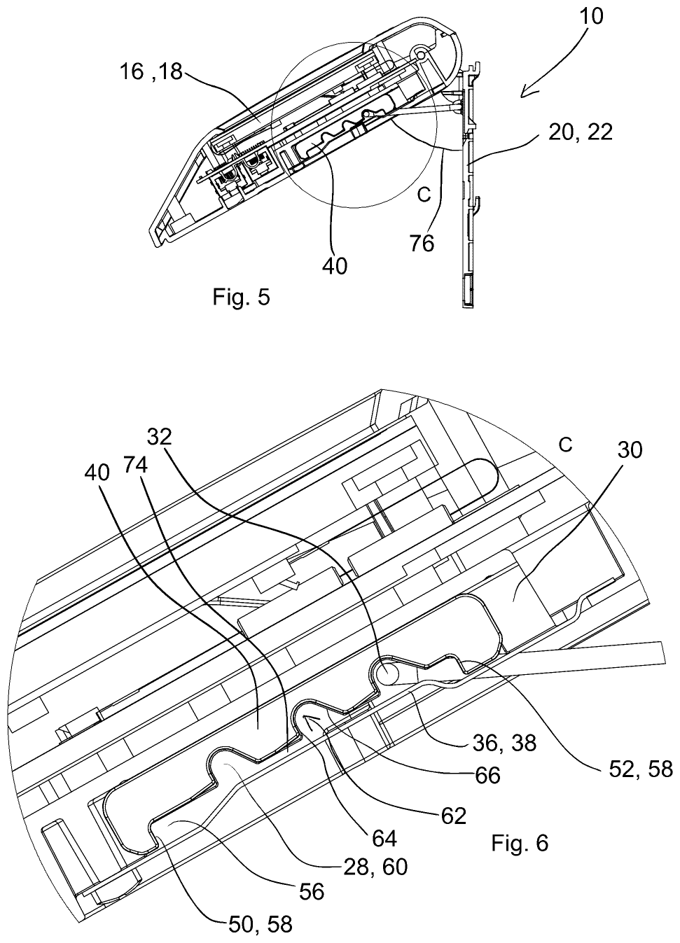

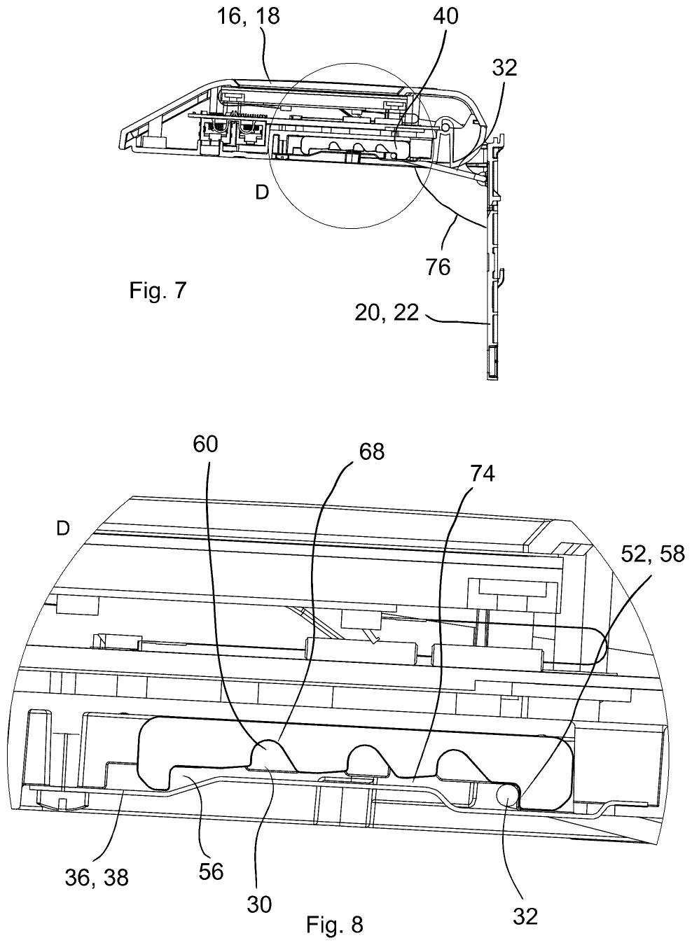

FIGS. 3 and 4 show representations corresponding to FIGS. 1 and 2, in which the hold-down clamp 38 is obscured for the sake of clarity of view. The adjustment unit 14 comprises a slide 40 which is recognizable in particular in FIG. 4. In FIGS. 5 to 10 the operator terminal 10 is shown in different states. Based thereon it is evident that the slide 40 in a first position is disposable such that the latching recesses 28 are unblocked for the disposition of the support element 32 such that the support element 32 can be inserted into one of the latching recesses 28 (FIG. 5 to 6 and 9 to 10). In FIGS. 7 and 8 the operator terminal 10 is shown in a state in which the slide 40 is disposed in a second position such that the latching recesses 28 are blocked for the disposition of the support element 32 such that the support element 32 is preferably not insertable into any of the latching recesses 28. The slide 40 can be displaceable along a sliding axis 42 from the first position into the second position and conversely.

As in particular FIG. 4 shows the latching element 30 can comprise a first latching element part 44, a second latching element part 46 and a sliding groove 48 extending along the sliding axis 42 between the first latching element part 44 and the second latching element part 46. The slide 40 is preferably disposed in the slide groove 48. The latching recesses 28 are preferably disposed in the first latching element part 44 and in the second latching element part 46 such that each of the latching recesses 28 intersect the slide groove 48 at right angles.

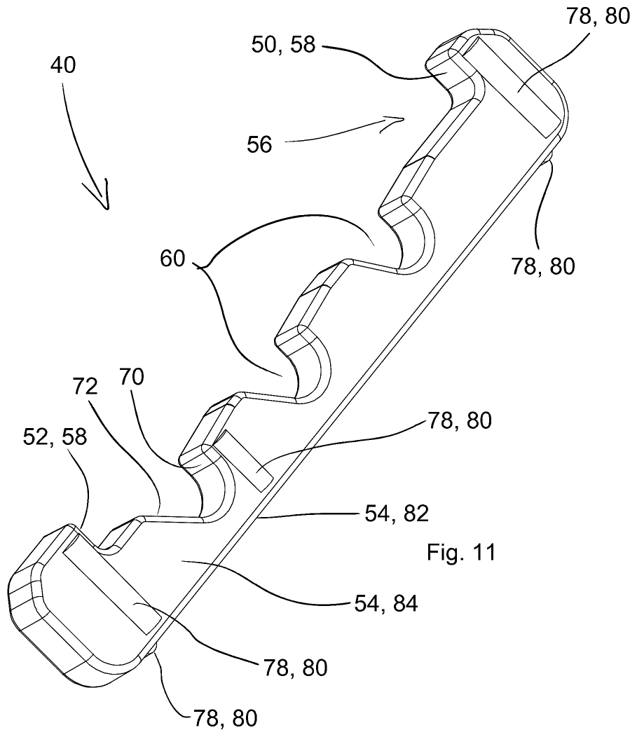

A detail view of the slide 40 is represented in FIG. 11. FIG. 11 shows that the slide 40 preferably comprises a first entrainment projection 50 and a second entrainment projection 50 disposed opposite the first entrainment projection 50 with respect to the sliding axis 42. On the first entrainment projection 50 is preferably disposable the support element 32 for displacing the slide 40 from the second position into the first position and on the second entrainment projection 52 is preferably disposable the support element 32 for displacing the slide 40 from the first position into the second position. In this way the slide 40 can be displaceable by means of the support element 32.

FIG. 11 shows that the slide 40 can comprise a base body 54 with a C-form slot 56 wherein the first entrainment projection 50 and the second entrainment projection 52 are each formed by a slot end 58 of the slot 56. The support element 32 can thus be moved in the slot 56 from the second entrainment projection 52 to the first entrainment projection 50.

FIG. 11 shows moreover that the slide 40 can comprise three slide recesses 60. The number of slide recesses 60 herein preferably corresponds to the number of latching recesses 28. In the first position represented in FIGS. 5 to 6 and 9 to 10 the latching recesses 28 and the slide recesses 60 are preferable disposed such that they are in alignment with one another such that, in the views transversely to the sliding axis 42 shown here, the latching recesses 28 and the slide recesses 60 are in flush alignment with one another. The latching recesses 28 are consequently unblocked for the disposition of the support element 32 such that, as shown in FIGS. 5 and 6, the support element 32 can be disposed in one of the latching recesses 28 and simultaneously in one of the slide recesses 60. FIGS. 1 to 4 also show a corresponding disposition. With respect to the sliding axis 42, the slide recesses 60 are preferably disposed between the first entrainment projection 50 and the second entrainment projection 52 in the C-form slot 56. By providing three latching recesses 28 and three slide recesses 60 the operating part 16 and the base part 20 can be secured in place in three different positions with respect to one another.

The representation in FIG. 6 illustrates that each of the latching recesses 28 can comprise a latching recess contour 62 with a first end segment 64 and a second end segment 66, wherein the first end segment 64 is preferably disposed perpendicular to the sliding axis 42 and the second end segment 66 is preferably disposed at an oblique angle with respect to the sliding axis 42. Due to the multiplicity of the latching recesses 28 disposed successively along the sliding axis 42 the slide 40 can therewith comprise a sawtooth contour disposed along the sliding axis 42. As becomes evident based on FIG. 5 through the disposition of the first end segment 64 perpendicular to the sliding axis 42 the support element 32 can be braced on the first end segment 64. By disposing the second end segment 66 obliquely to the sliding axis 42 the support element 32 can at the second end segment 66 slide out of the particular latching recess 28.

The view in FIG. 11 shows that the slide recesses 60 in each case comprise a slide recess contour 68. The slide recess contour 68 is, at least segmentally, developed geometrically similar to the latching recess contour 62. The slide recess contour 68 can herein be developed in particular centrally elongated with respect to the latching recess contour 62 such that in the first position, shown in FIGS. 5 and 6, of the slide 40 each of the slide recesses 60 is disposed at a set-back with respect to each corresponding latching recess contour 62. Corresponding to the latching recess contour 62 the slide recess contour 68 can comprise a first end segment 70 and a second end segment 72, wherein the first end segment 70 is developed shorter than the first end segment 64 of the latching recess contour 62. It is thereby avoided that the support element 32 becomes jammed. The latching recesses 28 are preferably disposed such that the first end segment 70 is oriented toward the first entrainment projection 50 and the second end segment 72 is oriented toward the second entrainment projection 52.

In particular in the representation of FIGS. 1 and 2 as is in the detail view of FIGS. 6, 8 and 10 the hold-down clamp 38 for guiding the support element 32 can be discerned. The hold-down clamp 38 is preferably disposed such that, starting from the position depicted in FIG. 6, it must be lifted through the support element 32 in order to displace the slide 40. With the aid of the hold-down clamp 38 the support element 32 can be retained in the C-form slot 56 for the displacement of the slide 40. In addition, in the first position of slide 40 the support element can be latched in one of the latching recesses 28 due to the presence of the hold-down clamp 38. As in particular the sectional views of FIGS. 6, 8 and 19 show the hold-down clamp 38 can be developed in the form of a U and at least segmentally be disposed in the slot 56. Based on these views, it becomes additionally evident that the hold-down clamp 38 is fastened on one side to the end of the slide groove 48 to the latching element 30 by a screw coupling. Between the slide 40 and the hold-down clamp 38 an air gap 74 can be disposed. The support element 32 is preferably developed as a bracket disposed between the hold-down clamp 38 and the slide 40 (see in particular FIGS. 1 and 2).

Based on the states shown in FIGS. 5 to 10 the fundamental mechanism of function of the adjustment unit 14 can also be explained. Starting point is the assumption that the base part 20 is disposed such that it is fixedly secured in place. In the state shown in FIGS. 5 and 6 the slide 40 is in the first position and the support element 32 is disposed in the topmost of the latching recesses 28 such that between the operating part 16 and the base part 20 a flap angle 76 of greater than 0°, preferably of approximately 60°, is disposed. By manually lifting the operating part 16 such that the flap angle 76 is further increased, the support element 32 can be disengaged against the resistance of the hold-down clamp 38 from the latching recess 28 and be brought into contact on the second entrainment projection 52.

By further increasing the flap angle 76, preferably to greater than or equal to 90°, through further lifting of the operating part 16 the slide 40 can be moved along the sliding axis 42 into the second position. The corresponding state of the adjustment unit 14 is shown in FIGS. 7 and 8. By disposing the slide 40 in the second position the latching recesses 28 are blocked by the slide 40. This enables the subsequent folding down of the operating part 16, thus decreasing the flap angle 76, at which the support element 76 is moved along the C-form slot 56 of slide 40 without the support element 32 becoming disposed in one of the latching recesses 28.

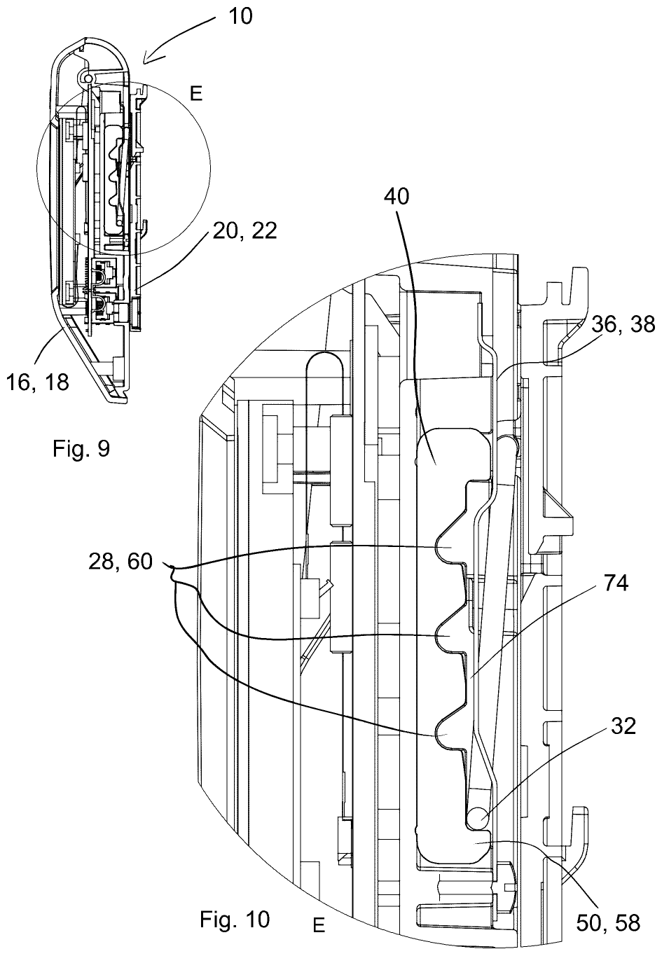

Before the flap angle 76 has reached a value of 0° during the folding down of the operating part 16, the support element 32 herein reaches the first entrainment projection 50. Further folding down of the operating part 16 ensures that the slide 40 is guided by the support element 32 along the sliding axis 42 back into the first position such that the latching recesses 28 are again unblocked (see FIGS. 9 and 10). By the subsequent lifting of the operating part 16 the support element 32 can be disposed in one of the latching recesses 28 and the operating part 16 can therewith be engaged.

To avoid an unintentional displacement of the slide 40, for example when moving the support element 32 along the blocked latching recesses 28, in particular the slide 40 can comprise impedants 80 developed as impedant projections 78 for increasing the friction between the latching element 30 and the slide 40. As is shown in the representation of the slide 40 in FIG. 11 the impedant projections 78 can be disposed in particular on a back side 82, opposite the slot 56, of slide 40 and on a side surface 84 lateral to the slot 56 of slide 40.

FIGS. 13 and 14 show each an embodiment example of the environment simulation chamber 12, wherein the operator terminal 10 is disposed on the outside of a door 86 of the environment simulation chamber 10. It is herein discernable that the base part 20 is in direct contact on the door 86.

### LIST OF REFERENCE SYMBOLS

10 Operator terminal
12 Environment simulation chamber
14 Adjustment unit
16 Operating part
18 First flap element
20 Base part
22 Second flap element
24 Input and/or output unit
26 Rotational axis
28 Latching recess
30 Latching element
32 Support element
34 Support element axis
36 Leaf spring
38 Hold-down clamp
40 Slide
42 Sliding axis
44 First latching element part
46 Second latching element part
48 Slide groove
50 First entrainment projection
52 Second entrainment projection
54 Base body
56 Slot
58 Slot end
60 Slide recess
62 Latching recess contour
64 First end segment
66 Second end segment
68 Slide recess contour
70 First end segment
72 Second end segment
74 Air gap
76 Flap angle
78 Impedant projection
80 Impedants
82 Back surface
84 Side surface
86 Door

1. An adjustment unit for an operator terminal, comprising:
a first flap element;
a second flap element;
a rotational axis about which the first flap element and the second flap element can be turned relative to one another;
a latching element disposed on the first flap element and comprising at least one latching recess;
a support element disposed on the second flap element and disposable in one of the at least one latching recesses; and
a slide that is displaceable along a sliding axis, wherein the slide is disposable in a first position such that the at least one latching recess is unblocked for disposition of the support element and wherein the slide is disposable in a second position such that the at least one latching recess is blocked for disposition of the support element.

2. The adjustment unit of claim 1, wherein the slide comprises a first entrainment projection and a second entrainment projection disposed opposite the first entrainment projection with respect to the sliding axis, wherein the support element is disposable on the first entrainment projection for displacing the slide from the second position into the first position and on the second entrainment projection for displacing the slide from the first position into the second position.

3. The adjustment unit of claim 2, wherein the slide comprises a base body with a C-shaped slot, wherein the first entrainment projection and the second entrainment projection are each formed by a slot end of the slot.

4. The adjustment unit of claim 1, wherein the slide comprises at least one slide recess, wherein in the first position the at least one latching recess and the at least one slide recess are disposed in alignment with one another.

5. The adjustment unit of claim 4, wherein the at least one slide recess is disposed between the first entrainment projection and the second entrainment projection with respect to the sliding axis.

6. The adjustment unit of claim 1, wherein each of the at least one latching recesses comprises a latching recess contour with a first end segment and a second end segment, wherein the first end segment is disposed perpendicular to the sliding axis and the second end segment is disposed obliquely with respect to the sliding axis.

7. The adjustment unit of claim 6, wherein the at least one slide recess comprises a slide recess contour which is at least segmentally developed geometrically similar to the latching recess contour.

8. The adjustment unit of claim 6, wherein the at least one latching recess is disposed such that the first end segment is oriented toward the first entrainment projection and the second end segment is oriented toward the second entrainment projection.

9. The adjustment unit of claim 1, wherein the latching element comprises a first latching element part, a second latching element part and a slide groove extending along the sliding axis between the first latching element part and the second latching element part, in which the slide is disposed.

10. The adjustment unit of claim 1, wherein at least one of the latching element and the slide comprise impedants for increasing friction between the latching element and the slide.

11. The adjustment unit of claim 10, wherein the impedants are developed as impedant projections disposed on at least one of the slide and the latching element.

12. The adjustment unit of claim 1, further comprising a hold-down clamp for guiding the support element.

13. The adjustment unit of claim 12, wherein an air gap is disposed between the slide and the hold-down clamp.

14. The adjustment unit of claim 1, wherein the first flap element is developed as an operating part and the second flap element is developed as a base part of the operator terminal.

15. An adjustment unit for an operator terminal, comprising:
a first flap element;
a second flap element;
a rotational axis about which the first flap element and the second flap element can be turned relative to one another;
a latching element disposed on the first flap element and comprising latching recesses;
a support element disposed on the second flap element and disposable in one of the latching recesses;
a slide that is displaceable along a sliding axis between a first position where the latching recesses are unblocked for disposition of the support element and a second position where the latching recesses are blocked for disposition of the support element;
wherein the slide comprises a first entrainment projection and a second entrainment projection disposed opposite the first entrainment projection with respect to the sliding axis, and wherein the support element is disposable on the first entrainment projection for displacing the slide from the second position into the first position during rotation of the flap elements and on the second entrainment projection for displacing the slide from the first position into the second position during rotation of the flap elements.

16. The adjustment unit of claim 15, wherein the slide comprises a base body with a C-shaped slot, and wherein the first entrainment projection and the second entrainment projection are each formed by a slot end of the C-shaped slot.

17. The adjustment unit of claim 15, wherein the slide comprises slide recesses, and wherein in the first position the latching recesses and the slide recesses are disposed in alignment with one another.
